(19) United States
(12) Patent Application Publication
(10) Pub. No.: US 2009/0206722 A1
(43) Pub. Date: Aug. 20, 2009

(54) ELECTRON EMISSION DEVICE, ELECTRON EMISSION TYPE BACKLIGHT UNIT EMPLOYING THE ELECTRON EMISSION DEVICE, AND METHOD OF MANUFACTURING THE ELECTRON EMISSION DEVICE

(76) Inventors: Kun-Hong Choi, Suwon-si (KR); Young-Chul Choi, Suwon-si (KR)

Correspondence Address: CHRISTIE, PARKER & HALE, LLP, PO BOX 7068, PASADENA, CA, 91109-7068, US

(21) Appl. No.: 12/363,448

(22) Filed: Jan. 30, 2009

(30) Foreign Application Priority Data
Feb. 19, 2008 (KR) 10-2008-0014905

(51) Int. Cl. H01J 1/00; H01J 9/00

(52) U.S. Cl. 313/235; 445/23

(57) ABSTRACT

An electron emission device is provided having a first substrate and a first electrode on the first substrate. A second electrode is electrically insulated from the first electrode. An electron emission source is electrically connected to the first electrode. A blocking layer is between the first electrode and the second electrode.

### CROSS-REFERENCE TO RELATED PATENT APPLICATION

This application claims the priority to and the benefit of Korean Patent Application No. 10-2008-0014905, filed on Feb. 19, 2008, in the Korean Intellectual Property Office, the entire content of which is incorporated herein by reference.

### BACKGROUND OF THE INVENTION

1. Field of the Invention

The present invention relates to an electron emission device, an electron emission type backlight unit including the electron emission device, and a method of manufacturing the electron emission device.

2. Description of the Related Art

Generally, electron emission devices use a hot cathode or a cold cathode as an electron emission source. The electron emission devices that use a cold cathode include field emission device (FED) type devices, surface conduction emitter (SCE) type devices, metal insulator metal (MIM) type devices, metal insulator semiconductor (MIS) type devices, ballistic electron surface emitting (BSE) type devices, and the like.

FED type devices use the principle that, when a material having a low work function or a high β function is used as an electron emission source, the material readily emits electrons in a vacuum due to an electric field formed between two or more electrodes. FED type devices that employ a tapered tip structure formed of Mo, Si, and the like as a main component, a carbon group material such as graphite and diamond like carbon (DLC), or a nanostructure such as nanotubes or nanowires have been developed.

In SCE type devices, an electron emission source is formed by disposing a conductive thin film between a first electrode and a second electrode, which face each other on a first substrate, and forming a micro-crack in the conductive thin film. SCE type devices emit electrons from the electron emission source, which is the micro-crack, by allowing a current to flow to the surface of the conductive thin film by applying voltage to the first and second electrodes.

MIM type devices and MIS type devices include electron emission sources respectively formed of an MIM structure and an MIS structure. According to MIM type and MIS type devices, electrons are emitted as the electrons move or accelerate from a metal or semiconductor that has a high electron potential to a metal that has a low electron potential, when a voltage is applied between the two metals of an MIM type device or between the metal and the semiconductor of an MIS type device, wherein the insulator is located between the two metals of the MIM type device, and between the metal and the semiconductor of the MIS type device.

BSE type devices emit electrons by forming an electron supply layer, formed of a metal or a semiconductor, on an ohmic electrode; forming an insulation layer and a metal thin film on the electron supply layer; and applying voltage to the ohmic electrode and the metal thin film. By using a principle that when the size of a semiconductor is reduced to a size smaller than the mean free path of electrons in the semiconductor, the electrons move without being scattered.

FED type devices can be largely categorized into top gate types and under gate types according to locations of a cathode and a gate electrode. Also, FED type devices can be categorized into two-electrode tubes, three-electrode tubes, and four-electrode tubes according to the number of electrodes used. In such conventional electron emitting devices, electrons are emitted from an electron emission source by an electric field formed between the cathode electrode and the gate electrode. The electrons are emitted from an electron emission source that is disposed around an electrode that operates as a cathode from among the cathode electrode and the gate electrode. The emitted electrons first move towards an electrode that operates as an anode, and then are accelerated towards a phosphor layer by a strong electric field of the anode.

Such conventional FED type devices use a photo resist (PR) sacrificial layer due to reverse exposure of the electron emission source (generally a carbon nanotube (CNT)). However, when only the PR sacrificial layer is used, the PR and CNT may react to each other while exposing or drying the electron emission source. Accordingly, a uniformity of the electron emission source cannot be guaranteed while the size of the electron emission source is determined, and thus an electric field emitting area is reduced.

### SUMMARY OF THE INVENTION

The exemplary embodiments of the present invention provide an electron emission device with an improved uniformity of the electron emission sources, an electron emission type backlight unit including the electron emission device, and a method of manufacturing the electron emission device.

In an exemplary embodiment of the present invention, an electron emission device is providing having a first substrate, a first electrode on the first substrate, a second electrode electrically insulated from the first electrode, an electron emission source electrically connected to the first electrode, and a blocking layer disposed between the first electrode and the second electrode.

The electron emission device may further include an opening in the blocking layer.

A diameter of the opening may be larger than a diameter of the electron emission source.

The blocking layer may include at least one metal.

The at least one metal may include at least any one of molybdenum, chrome, and aluminum.

The blocking layer may have a thickness in a range between 50 nm and 500 nm.

The second electrode may be over the first electrode and the electron emission source and may have an aperture pattern.

The electron emission device may further include an insulating layer disposed between the first electrode and the second electrode for insulating the first electrode and the second electrode.

The electron emission device may further include an electron emission source hole in the insulating layer and the second electrode such that the first electrode is exposed.

The electron emission source may be inside the electron emission source hole.

In an exemplary embodiment of the present invention, an electron emission type backlight unit is provided including an electron emission device, a phosphor layer, and a third electrode. The electron emission device includes a first substrate, a first electrode on the first substrate, a second electrode electrically insulated from the first electrode, an electron emission source electrically connected to the first electrode, and a blocking layer disposed between the first electrode and the second electrode. The phosphor layer faces the electron emission source. The third electrode is for accelerating electrons emitted from the electron emission device toward the phosphor layer.

In an exemplary embodiment of the present invention, a method of manufacturing an electron emission device is provided. A first electrode is formed on a substrate. A blocking layer is formed on the first electrode. An insulating layer and a second electrode are formed on the blocking layer. A first opening is formed on the blocking layer. A photo resist sacrificial layer is formed on the first electrode, the second electrode, and the blocking layer. A second opening is formed on the photo resist sacrificial layer. An electron emission source is formed on the first electrode. At least a part of the blocking layer is etched.

A diameter of the electron emission source may be substantially identical to a diameter of the first opening.

Forming the blocking layer may be performed by using at least one method from among plasma enhanced chemical vapor deposition, sputtering, and E-beam evaporation.

Forming the insulating layer and the second electrode may include depositing a material for the insulating layer to cover the substrate, the first electrode, and the blocking layer; depositing an electrode material on the insulating layer; forming the second electrode by patterning the deposited electrode material; and forming electron emission source holes by patterning the second electrode and the insulating layer.

A diameter of the first opening may be smaller than a diameter of the electron emission source holes.

A size of the second opening may be substantially identical to a size of the first opening.

The electron emission source may be on the first electrode and may be exposed by the first opening and the second opening.

### BRIEF DESCRIPTION OF THE DRAWINGS

FIG. 1 is a partial perspective view of an electron emission type backlight unit including an electron emission device.

FIG. 2 is a cross-sectional view taken along a line II-II of FIG. 1.

FIG. 3 is a first diagram illustrating a sequentially method of manufacturing an electron emission device according to an embodiment of the present invention.

FIG. 4 is a second diagram sequentially illustrating a method of manufacturing an electron emission device according to an embodiment of the present invention.

FIG. 5 is a third diagram sequentially illustrating a method of manufacturing an electron emission device according to an embodiment of the present invention.

FIG. 6 is a fourth diagram sequentially illustrating a method of manufacturing an electron emission device according to an embodiment of the present invention.

FIG. 7 is a fifth diagram sequentially illustrating a method of manufacturing an electron emission device according to an embodiment of the present invention.

FIG. 8 is a sixth diagram sequentially illustrating a method of manufacturing an electron emission device according to an embodiment of the present invention.

FIG. 9 is a seventh diagram sequentially illustrating a method of manufacturing an electron emission device according to an embodiment of the present invention.

### DETAILED DESCRIPTION

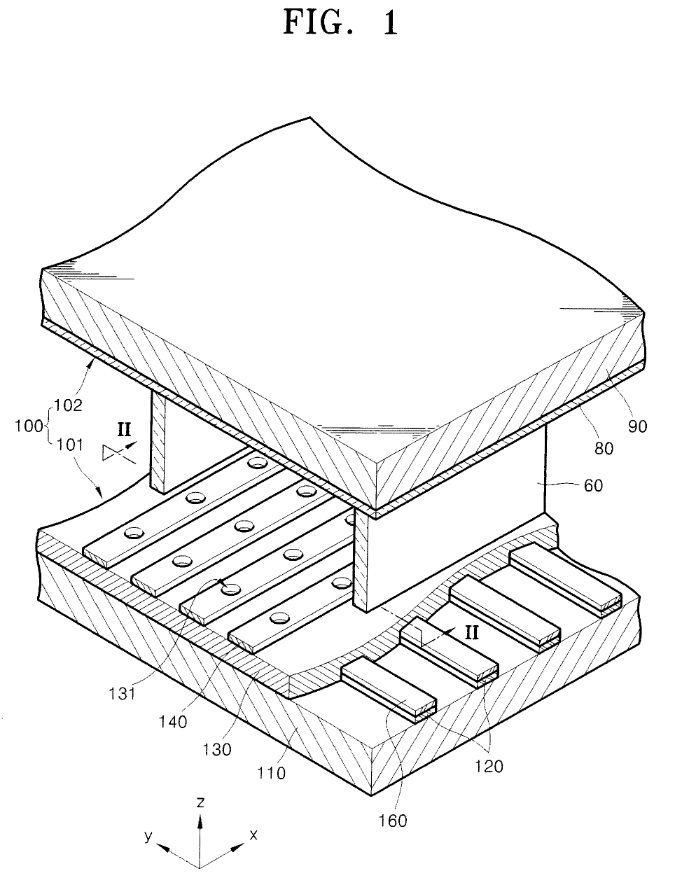

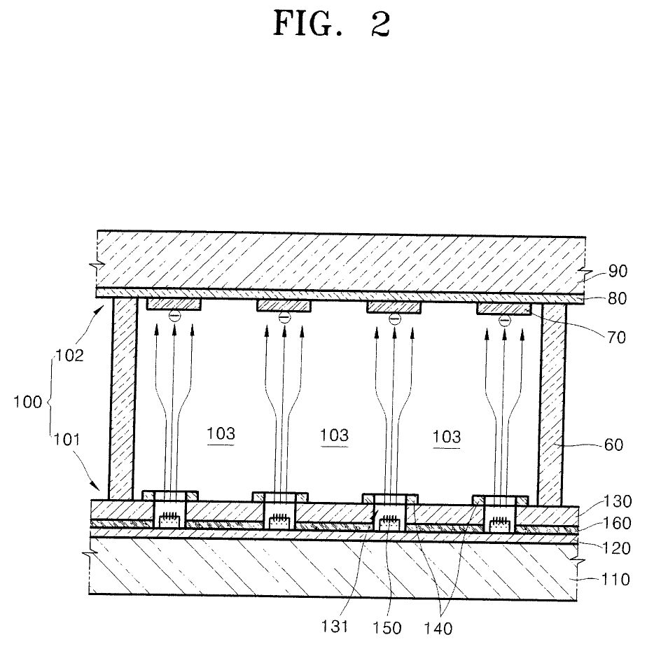

FIG. 1 is a partial perspective view of an electron emission type backlight unit 100 including an electron emission device 101, and FIG. 2 is a cross-sectional view taken along a line II-II of FIG. 1. The electron emission type backlight unit 100 includes the electron emission device 101 and a front panel 102, which are disposed in parallel and form a luminance space 103 which is in a vacuum state, and spacers 60, which maintain a space between the electron emission device 101 and the front panel 102.

The electron emission device 101 includes a first substrate 110, a first electrode 120, an insulating layer 130, a second electrode 140, an electron emission source 150, and a blocking layer 160.

The first and second electrodes 120, 140 are disposed such as to cross each other on the first substrate 110, and the insulating layer 130 is disposed between the first and second electrodes 120, 140 and electrically insulates the first and second electrodes 120, 140. Also, electron emission source holes 131 are formed in areas wherein the first and second electrodes 120, 140 cross each other. The electron emission sources 150 are disposed inside the electron emission source holes 131.

The first substrate 110 has a plate shape with a thickness (e.g., a predetermined thickness). The first substrate 110 may be formed of quartz glass, glass containing impurities such as a small amount of Na, plate glass, an SiO₂ coated glass substrate, or an aluminum oxide or ceramic substrate. Also, when a flexible display apparatus is realized, the first substrate may be formed of a flexible material.

The first electrode 120 and the second electrode 140 may be formed of a metal, such as Al, Ti, Cr, Ni, Au, Ag, Mo, W, Pt, Cu, and Pd, or an alloy thereof. Alternatively, the first and second electrodes 120, 140 may be formed of a printed conductive material containing glass and a metal, such as Pd, Ag, RuO₂, and Pd—Ag, or metal oxide thereof. Alternatively, the first and second electrodes 120, 140 may be formed of a transparent conductor, such as In₂O₃ and SnO₂, or a semiconductor material, such as polycrystalline silicon.

The insulating layer 130 insulates the first substrate 110 and the second electrode 140. The insulating layer 130 may be formed of a conventional insulating material. For example, the insulating layer 130 may be silicon oxide, silicon nitride, frit, or the like. Examples of the frit include PbO—SiO₂ group frit, PbO—B₂O₃—SiO₂ group frit, ZnO—SiO₂ group frit, ZnO—B₂O₃—SiO₂ group frit, Bi₂O₃—SiO₂ group frit, and Bi₂O₃—B₂O₃—SiO₂ group frit, but are not limited thereto.

An electron emission material is included in the electron emission source 150. The electron emission material may be a carbon nanotube (CNT), wherein the work function is low and the β function is high. Specifically, the CNT has excellent electron emission characteristics, and thus can be efficiently operated at low voltage. Accordingly, an apparatus using the CNT as an electron emission source can be enlarged. However, the electron emission material is not limited to CNT, and may include a carbon group material, such as graphite, a diamond, and diamond like carbon, or a nanomaterial, such as a nanotube, a nanowire, and a nanorod. Alternatively, the electron emission material may include carbide conduction carbon.

The blocking layer 160 is formed between the first electrode 120 and the insulating layer 130.

A conventional FED type electron emission device uses a photo resist (PR) sacrificial layer due to reverse exposure of an electron emission source (generally CNT). However, when only the PR sacrificial layer is used, the PR and CNT may react to each other while exposing or drying the electron emission source, and thus the bottom of the electron emission source may cave in. Accordingly, uniformity of the electron emission source cannot be guaranteed, and thus an electric field emitting area is reduced.

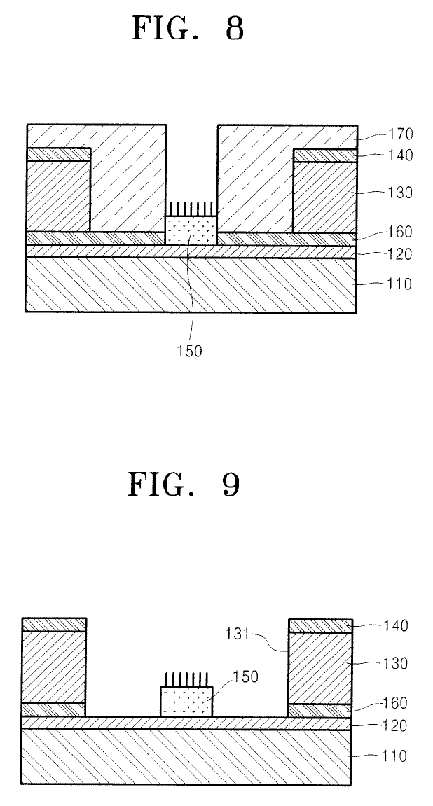

Accordingly, the electron emission device 101 includes the blocking layer 160 such that the electron emission source 150 and a PR sacrificial layer 170 illustrated in FIG. 8 do not react to each other by blocking the electron emission source 150 and the PR sacrificial layer 170 at a part that the electron emission source 150 is formed. Accordingly, the electron emission sources 150 are uniformly formed. In other words, the electron emission sources 150 can have uniform diameters.

In an exemplary embodiment, the blocking layer 160 is formed of a metal material. The blocking layer 160 may be formed of any metal material that can prevent UV penetration and can be etched, such as molybdenum (Mo), chrome (Cr), or aluminum (Al), and can be deposited by using a chemical vapor deposition (CVD) method, a plasma enhanced (PE) CVD method, a low pressure (LP) CVD method, an electron cyclotron resonance (ECR) CVD method, a sputtering method, an E-beam evaporation method or the like. Also, the thickness of the blocking layer 160 is in the range between 50 nm and 500 nm. If the thickness of the blocking layer 160 is less than 50 nm, UV may penetrate and thus the performance of the blocking layer 160 may deteriorate. If the thickness of the blocking layer 160 is more than 500 nm, an etching process is not convenient.

The front panel 102 includes a second substrate 90, which can penetrate visible light, a phosphor layer 70, which is disposed on the second substrate 90 and generates the visible light by being excited by electrons emitted from the electron emission device 101, and a third electrode 80, which accelerates the electrons emitted from the electron emission device 101 toward the phosphor layer 70.

The second substrate 90 may be formed of the same material as the first substrate 110 described above, and visible light may penetrate the second substrate 90.

The third electrode 80 may be formed of the same material as the first electrode 120 or the second electrode 140.

The phosphor layer 70 is formed of a cathode luminescence (CL) type phosphor substance, which generates the visible light by being excited by the accelerated electrons. Examples of the phosphor substance include a red light phosphor substance, such as SrTiO₃:Pr, Y₂O₃:Eu, and Y₂O₃S:Eu, a green light phosphor substance, such as Zn(Ga, Al)₂O₄:Mn, Y₃(Al, Ga)₅O₁₂:Tb, Y₂SiO₅:Tb, and ZnS:Cu,Al, and a blue light phosphor substance, such as Y₂SiO₅:Ce, ZnGa₂O₄, and ZnS:Ag,Cl. However, these are just examples of the phosphor substance and the present invention is not limited thereto.

In order for the electron emission type backlight unit 100 to normally operate, a space between the phosphor layer 70 and the electron emission device 101 should be maintained in a vacuum state. Accordingly, a spacer 60, which maintains an interval between the phosphor layer 70 and the electron emission device 101, and glass frit (not shown), which seals the space may be further included in the electron emission type backlight unit 100. The glass frit is disposed around the space in order to seal the space.

The electron emission type backlight unit 100 having the above structure operates as follows. A negative voltage is applied to the first electrode 120 and a positive voltage is applied to the second electrode 140 of the electron emission device 101, and thus electrons are emitted from the electron emission source 150 towards the second electrode 140 by an electric field formed between the first and second electrodes 120, 140. When a positive voltage, which is much greater than the positive voltage applied to the second electrode 140, is applied to the third electrode 80, the electrons emitted from the electron emission source 150 accelerate towards the third electrode 80. Visible light is generated as the electrons excite the phosphor layer 70 adjacent to the third electrode 80. The emission of the electrons can be controlled by a voltage applied to the second electrode 140.

The voltage applied to the first electrode 120 is not limited to the negative voltage, and any type of voltage can be applied as long as a suitable electric potential difference is formed between the first and second electrodes 120, 140 in order to emit the electrons.

The electron emission type backlight unit 100 illustrated in FIG. 1 and FIG. 2 can be used as a backlight unit of a non-emissive display device, such as TFT-LCD, as a surface light source. Also, in order to realize an image or to form a backlight unit having a dimming function as well as its function of generating the visible light as a surface light source, the first and second electrodes 120, 140 of the electron emission device 101 may cross each other. Accordingly, one of the first electrode 120 and the second electrode 140 may be formed of a structure having a main electrode portion and a branch electrode portion. The main electrode portion crosses the other electrode and the branch electrode portion protrudes from the main electrode portion in order to face the other electrode. An electron emission layer may be formed on the branch electrode portion or on the opposite side of the branch electrode portion.

A method of manufacturing the electron emission device according to the present invention will now be described.

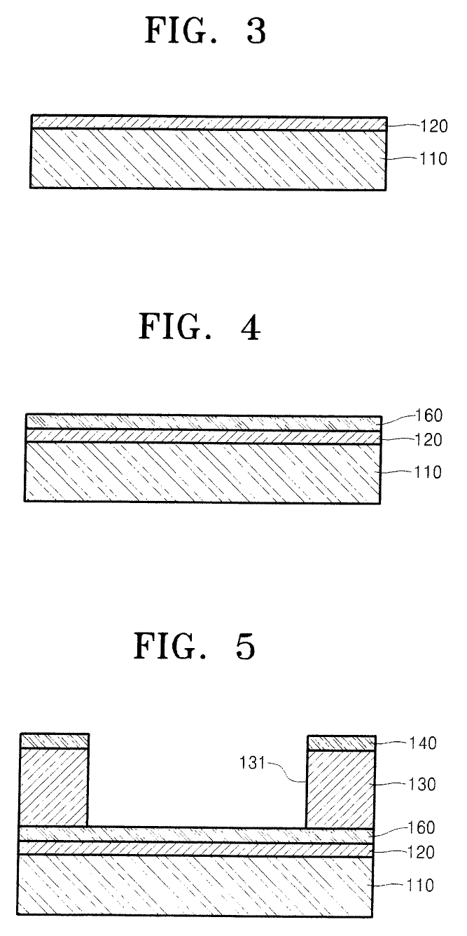

FIGS. 3-9 are diagrams sequentially illustrating a method of manufacturing an electron emission device according to an embodiment of the present invention.

First, an electrode material is deposited on the first substrate 110, and the first electrode 120 is formed by patterning the stacked electrode material as shown in FIG. 3. When the electrode material is a metal, the electrode material may be stacked by using a deposition method.

Subsequently, a blocking layer material is deposited on the first substrate 110 and the blocking layer 160 is formed by patterning the deposited blocking layer material as shown in FIG. 4.

A conventional FED type electron emission device uses a PR sacrificial layer due to reverse exposure of an electron emission source (generally a CNT). However, when only the PR sacrificial layer is used, the PR and CNT may react to each other while exposing or drying the electron emission source, and thus the bottom of the electron emission source may cave in slightly. Accordingly, uniformity of the electron emission source cannot be guaranteed, and thus an electric field emitting area is reduced.

Accordingly, the blocking layer 160, which is formed of a metal material, is included such that the electron emission source 150 and the PR sacrificial layer 170 do not react to each other. This is achieved by blocking the electron emission source 150 and the PR sacrificial layer 170 at a part where the electron emission source 150 is formed. Accordingly, the electron emission sources 150 are uniformly formed. In other words, the electron emission sources 150 can have uniform diameters.

The blocking layer 160 may be formed of any metal material that can prevent UV penetration and can be etched, such as molybdenum (Mo), chrome (Cr), or aluminum (Al), and can be deposited by using a CVD method, a PE CVD method, a LP CVD method, an ECR CVD method, a sputtering method, an E-beam evaporation method or the like. Also, the thickness of the blocking layer 160 is in a range between 50 nm and 500 nm.

Subsequently, the insulating layer 130 and the second electrode 140 are formed on the first substrate 110 as shown in FIG. 5.

A material for forming the insulating layer 130 is deposited to cover the first substrate 110, the first electrode 120, and the blocking layer 160. Then, the electrode material is deposited on the insulating layer 130 and the second electrode 140 is formed by patterning the deposited electrode material. Next, the electron emission source holes 131 are formed by patterning the second electrode 140 and the insulating layer 130. A part of the blocking layer 160 is exposed by forming the electron emission source holes 131.

A first opening 161 is formed on at least a part of the exposed blocking layer 160 as shown in FIG. 6. The size of the first opening 161 may be somewhat smaller than the diameter of the electron emission source hole 131. Also, the size of the first opening 161 may be substantially equal to the size of the electron emission source 150 that is to be generated.

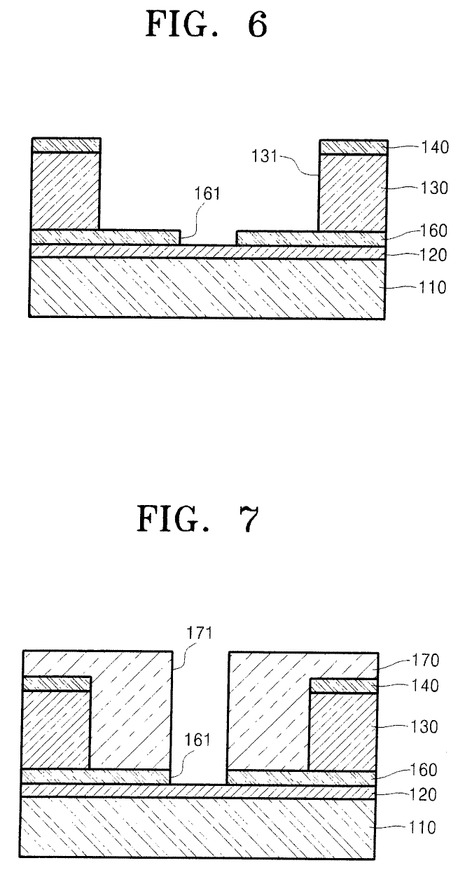

As shown in FIG. 7, the PR sacrificial layer 170 is formed on the first electrode 120, the second electrode 140, and the blocking layer 160. A second opening 171, which has substantially the same size as the first opening 161, is formed on the PR sacrificial layer 170. In other words, a UV blocking layer is not formed on a part that the electron emission layer is to be formed.

Because the PR sacrificial layer 170 is blocked from the first electrode 120 by the blocking layer 160, the electron emission source 150 and the PR sacrificial layer 170 do not react to each other, and thus the electron emission sources 150 can be uniformly formed.

Subsequently, the electron emission source 150 is formed on the first electrode 120, which is exposed through the first and second openings 161, 171 as shown in FIG. 8. In other words, a composition for forming the electron emission source 150 is printed on the first electrode 120, which is exposed through the first and second openings 161, 171. The composition may be a CNT, wherein the work function is low and the β function is high. Specifically, the CNT has an excellent electron emission characteristic, and thus can be efficiently operated at low voltage. Accordingly, an apparatus using the CNT as an electron emission source can be enlarged. However, the composition is not limited to CNT, and may include a carbon group material, such as graphite, a diamond, and diamond like carbon, or a nanomaterial, such as a nanotube, a nanowire, and a nanorod. Alternatively, the composition may include carbide conduction carbon.

Finally, the electron emission device is completed by removing the PR sacrificial layer 170 and etching the blocking layer 160 on the electron emission source hole 131 as shown in FIG. 9. The blocking layer 160 may be etched by using an etchant, such as H₂O₂.

By using the methods according to the exemplary embodiments of the present invention, uniformity of the electron emission source can be improved.

Also, according to the electron emission device, the electron emission type backlight unit including the electron emission device, and the methods of manufacturing the electron emission device of exemplary embodiments of the present invention, uniformity of the electron emission source is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electron emission device, comprising:
a first substrate;
a first electrode on the first substrate;
a second electrode electrically insulated from the first electrode;
an electron emission source electrically connected to the first electrode; and
a blocking layer between the first electrode and the second electrode.

2. The electron emission device of claim 1, further comprising an opening in the blocking layer.

3. The electron emission device of claim 2, wherein a diameter of the opening is larger than a diameter of the electron emission source.

4. The electron emission device of claim 1, wherein the blocking layer comprises at least one metal.

5. The electron emission device of claim 4, wherein the at least one metal comprises at least any one of molybdenum, chrome, and aluminum.

6. The electron emission device of claim 1, wherein the blocking layer has a thickness in a range between 50 nm and 500 nm.

7. The electron emission device of claim 1, wherein the second electrode is over the first electrode and the electron emission source and has an aperture pattern.

8. The electron emission of claim 1, further comprising an insulating layer between the first electrode and the second electrode for insulating the first electrode and the second electrode.

9. The electron emission device of claim 8, further comprising an electron emission source hole in the insulating layer and the second electrode such that the first electrode is exposed.

10. The electron emission device of claim 9, wherein the electron emission source is inside the electron emission source hole.

11. An electron emission type backlight unit, comprising:
an electron emission device comprising:
a first substrate;
a first electrode on the first substrate;
a second electrode electrically insulated from the first electrode;
an electron emission source electrically connected to the first electrode; and
a blocking layer between the first electrode and the second electrode;
a phosphor layer facing the electron emission source; and
a third electrode for accelerating electrons emitted from the electron emission device toward the phosphor layer.

12. A method of manufacturing an electron emission device, the method comprising:
forming a first electrode on a substrate;
forming a blocking layer on the first electrode;
forming an insulating layer and a second electrode on the blocking layer;
forming a first opening on the blocking layer;
forming a photo resist sacrificial layer on the first electrode, the second electrode, and the blocking layer, and forming a second opening on the photo resist sacrificial layer;
forming an electron emission source on the first electrode; and
etching at least a part of the blocking layer.

13. The method of claim 12, wherein a diameter of the electron emission source is substantially identical to a diameter of the first opening.

14. The method of claim 12, wherein forming the blocking layer is performed by using at least one method from among plasma enhanced chemical vapor deposition, sputtering, and E-beam evaporation.

15. The method of claim 12, wherein forming the insulating layer and the second electrode comprises:
depositing a material for the insulating layer to cover the substrate, the first electrode, and the blocking layer;
depositing an electrode material on the insulating layer;
forming the second electrode by patterning the deposited electrode material; and
forming electron emission source holes by patterning the second electrode and the insulating layer.

16. The method of claim 15, wherein a diameter of the first opening is smaller than a diameter of the electron emission source holes.

17. The method of claim 12, wherein a size of the second opening is substantially identical to a size of the first opening.

18. The method of claim 12, wherein the electron emission source is on the first electrode and is exposed by the first opening and the second opening.

19. The method of claim 12, wherein the blocking layer comprises at least one metal.

20. The method of claim 19, wherein the at least one metal comprises at least any one of molybdenum, chrome, and aluminum.
